(19) United States
(12) Patent Application Publication
(10) Pub. No.: US 2023/0070229 A1
(43) Pub. Date: Mar. 9, 2023

(54) OPTICAL DISTANCE MEASURING APPARATUS

(71) Applicant: DENSO CORPORATION, Kariya-city (JP)

(72) Inventor: Fumiaki MIZUNO, Kariya-city (JP)

(21) Appl. No.: 18/055,165

(22) Filed: Nov. 14, 2022

Related U.S. Application Data
(63) Continuation of application No. PCT/JP2021/016006, filed on Apr. 20, 2021.

(30) Foreign Application Priority Data
May 15, 2020 (JP) 2020-085661
Apr. 9, 2021 (JP) 2021-066173

(51) Int. Cl. G01S 17/10; G01S 7/497

(52) U.S. Cl. CPC G01S 17/10; G01S 7/497; G01S 17/931

(57) ABSTRACT

An optical distance measuring apparatus is provided with: a light emitting portion configured to emit irradiation light; a light receiving portion configured to output a signal according to an intensity of incident light including a reflected light resulting from the emitted irradiation light; a case that accommodates the light emitting portion and the light receiving portion; a distance measuring portion configured to perform a distance measurement process of measuring a distance to an object according to the intensity of the incident light; an error detecting portion configured to perform an error detection process of detecting an error in the light emitting portion using a reflected light resulting from the irradiation light emitted in a period when the distance measurement process is not performed.

### CROSS-REFERENCE TO RELATED APPLICATION

The present application is a continuation application of International Application No. PCT/JP2021/016006, filed on Apr. 20, 2021, which claims priority to Japanese Patent Application No. 2020-085661 filed on May 15, 2020 and Japanese Patent Application No. 2021-066173 filed on Apr. 9, 2021. The contents of these applications are incorporated herein by reference in their entirety.

### BACKGROUND

### Technical Field

The present disclosure relates to an optical distance measuring apparatus.

### Background Art

There is a known optical distance measuring apparatus provided with: a light emitting portion that emits irradiation light; and a light receiving portion that receives light including a reflected light resulting from the irradiation light.

### SUMMARY

In the present disclosure, provided is an optical distance measuring apparatus as the following.

The optical distance measuring apparatus includes: a light emitting portion configured to emit irradiation light; a light receiving portion configured to output a signal according to an intensity of incident light, the incident light including a reflected light resulting from the emitted irradiation light; a case; a distance measuring portion configured to perform a distance measurement process of measuring a distance to an object; and an error detecting portion configured to perform an error detection process of detecting an error in the light emitting portion using a reflected light resulting from the irradiation light emitted in a period when the distance measurement process is not performed.

### BRIEF DESCRIPTION OF THE DRAWINGS

The above-described object, other objects, characteristics, and advantages of the present disclosure will be more clarified by a detailed description provided below with reference to the attached drawings. Here below is a brief description of the drawings.

FIG. 1 is an explanatory drawing schematically illustrating a configuration of an optical distance measuring apparatus as one embodiment of the present disclosure.

FIG. 2 is a flowchart illustrating a procedure of a control process to be performed in the optical distance measuring apparatus.

FIG. 3 is a timing diagram of the control process.

FIG. 4 is an explanatory drawing illustrating regions divided using a scan angle.

FIG. 5 is a timing diagram of the control process in a second embodiment.

### DETAILED DESCRIPTION OF THE PREFERRED EMBODIMENTS

For example, Japanese Unexamined Patent Application Publication No. 2018-100880 discloses an optical distance measuring apparatus provided with a light guide for guiding, to a light receiving portion, light that serves to detect a fault in an optical system.

According to Japanese Unexamined Patent Application Publication No. 2018-100880, however, the optical distance measuring apparatus is provided with a light guiding portion for fault detection besides the light emitting portion and the light receiving portion. For the number of its components, the optical distance measuring apparatus may be large in size.

According to one embodiment of the present disclosure, an optical distance measuring apparatus is provided. This optical distance measuring apparatus is provided with: a light emitting portion configured to emit irradiation light; a light receiving portion configured to output a signal according to an intensity of incident light, the incident light including a reflected light resulting from the emitted irradiation light; a case that accommodates the light emitting portion and the light receiving portion; a distance measuring portion configured to perform a distance measurement process of measuring a distance to an object according to the intensity of the incident light; and an error detecting portion configured to perform an error detection process of detecting an error in the light emitting portion using a reflected light resulting from the irradiation light emitted in a period when the distance measurement process is not performed.

An optical distance measuring apparatus with this configuration performs an error detection process of detecting an error in the light emitting portion using a reflected light resulting from irradiation light that is emitted in a period when a distance measurement process is not performed. So, the optical distance measuring apparatus is capable of detecting an error in the light emitting portion without being provided with a light guiding portion for detecting an error in the light emitting portion. This will prevent an increase in the number of components of the optical distance measuring apparatus and in the size of the optical distance measuring apparatus.

The present disclosure can be put into practice in various forms. For example, the present disclosure can be implemented in the forms of: an error detecting device for an optical distance measuring apparatus; an error detecting method for an optical distance measuring apparatus; a computer program for implementing the device and the method; a recording medium storing the computer program; and the like.

### A. First Embodiment

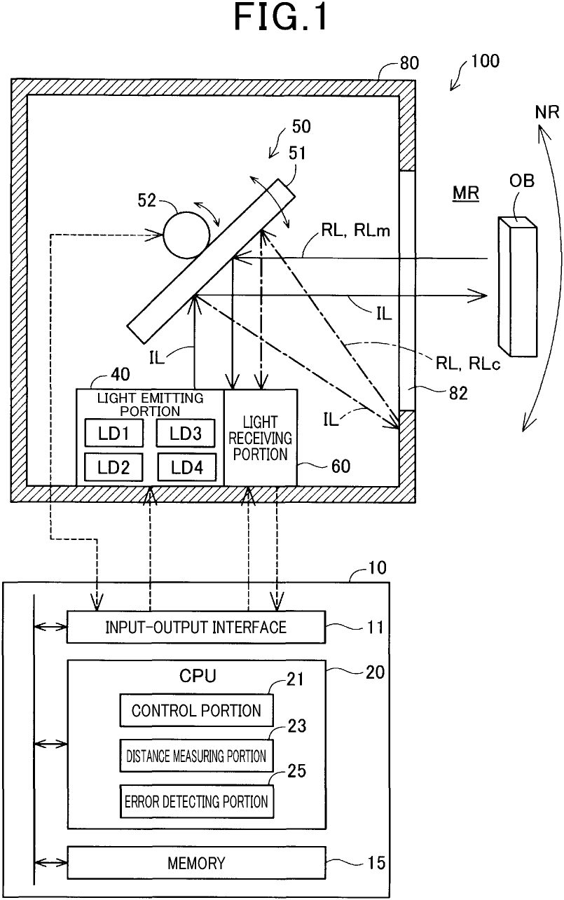

FIG. 1 illustrates an optical distance measuring apparatus 100 that detects the distance to an object OB by emitting irradiation light IL and receiving a reflected light RL reflected by the object OB. The optical distance measuring apparatus 100 is installed and used in a vehicle, for example. In the present embodiment, the optical distance measuring apparatus 100 is a LiDAR, which stands for light detection and ranging. The optical distance measuring apparatus 100 is provided with: a light emitting portion 40; a light receiving portion 60; a scanning portion 50; and a control device 10. The optical distance measuring apparatus 100 is further provided with a case 80; and the light emitting portion 40, the light receiving portion 60, and the scanning portion 50 are located in an internal space surrounded by inner wall faces of the case 80. The optical distance measuring apparatus 100 has a predetermined scan angle range NR. The irradiation light IL is emitted by the light emitting portion 40 and the reflected light RL is received by the light receiving portion 60 in units of unit scanning angles, the unit scan angle being obtained by dividing the scan angle range NR into multiple angles. The optical distance measuring apparatus 100 thereby collects detection points from the entire scan angle range NR to detect the distance. For the ease of description, FIG. 1 schematically illustrates a configuration of the optical distance measuring apparatus 100 and optical paths that do not match actual optical paths.

The light emitting portion 40 is provided with multiple light sources LD1, LD2, LD3, and LD4, and emits the irradiation light IL in units of unit scanning angles. The light sources LD1, LD2, LD3, and LD4 are infrared laser diodes, and emit infrared laser light as the irradiation light IL. In accordance with a light emission control signal that is input from the control device 10 for each unit scanning angle and serves to make the light sources LD1, LD2, LD3, and LD4 emit light, the light emitting portion 40 emits infrared laser light by driving the LD1, LD2, LD3, and LD4 with a driving signal of a pulsed driving waveform.

The light receiving portion 60 is provided with a light receiving element array and a light receiving lens both not shown in the figure. In response to receiving the reflected light RL resulting from the irradiation light IL emitted from the light emitting portion 40, the light receiving portion 60 performs a light receiving process of outputting a detection signal indicating a detection point. The light receiving element array is a planar optical sensor with a two-dimensional array of multiple light receiving elements. Each light receiving element is constituted by a single-photon avalanche diode (SPAD), for example, or another photodiode. The smallest unit for the light receiving process, i.e., a light receiving unit corresponding to a detection point may be referred to as the term “light receiving picture element”. The light receiving unit represents either a light receiving picture element consisting of a single light receiving element or a light receiving picture element consisting of multiple light receiving elements. The light receiving portion 60 outputs to the control device 10 an incident light intensity signal depending on the quantity or intensity of the incident light that enters the light receiving picture elements in units of unit scanning angles at which light emission is performed by the light emitting portion 40. The light receiving portion 60 can receive, besides the reflected light RL, ambient light (diffuse environmental light) such as sunlight, light from street lights, light from car lights, and reflected lights resulting from these lights reflected by the object OB.

The scanning portion 50 reciprocally scans the irradiation light IL emitted from the light emitting portion 40 in the scan angle range NR. The scanning portion 50 is provided with a motor 52 and a scanning mirror 51. In other words, the scanning portion 50 is a scanning portion provided with a mechanical moving part that makes the motor 52 operate the scanning mirror 51 for scanning.

The motor 52 is provided with a motor driver not shown in the figure. A rotation angle sensor for detecting the rotation angle of the motor 52, not shown in the figure is disposed on the motor 52. Receiving the rotation angle indicating signal outputted by the control device 10 in response to receipt of a rotation angle signal inputted from the rotation angle sensor, the motor driver controls the rotation angle of the motor 52 by changing the voltage applied to the motor 52. The motor 52 may be an ultrasonic motor, a brushless motor, or a brushed motor, for example, and provided with a well-known system for a reciprocating motion in the scan angle range NR. The scanning mirror 51 is attached to the motor 52.

The scanning mirror 51 is a reflector, i.e., a mirror that serves to scan the irradiation light IL emitted from the light emitting portion 40, in horizontal directions. Being reciprocally driven by the motor 52, the scanning mirror 51 causes horizontal scans in the scan angle range NR. The scanning mirror 51 may be a multi-faceted mirror such as a polygonal mirror, or a single-faceted mirror provided with a vertically-oscillating mechanism, or another single-faceted mirror provided with a vertically-oscillating mechanism. The irradiation light IL is scanned in accordance with the rotation angle of the scanning mirror 51. When the scanning mirror 51 is at a predetermined rotation angle, the irradiation light IL exits through a window portion 82 built in the case 80 to a measurement region MR, as indicated by a solid line in FIG. 1. The irradiation light IL that does not exit through the window portion 82 is reflected and diffused inside the case 80, as indicated by a dot-and-dash line in FIG. 1. The reflected light RL resulting from the irradiation light IL includes: a reflected light obtained by the irradiation light IL being reflected by the object OB in the measurement region MR, hereinafter referred to as “distance measurement reflected light RLm”; and an interior-diffused light obtained by the irradiation light IL being reflected inside the case 80, hereinafter referred to as “clutter reflected light RLc”. The distance measurement reflected light RLm enters the case 80 through the window portion 82 from the measurement region MR and reaches the light receiving portion 60, as indicated by a solid line in FIG. 1. Meanwhile, the clutter reflected light RLc is reflected by an inner wall of the case 80 and reaches the light receiving portion 60, as indicated by a dot-and-dash line in FIG. 1.

The control device 10 is provided with: a central processing unit (CPU) 20 as a computing portion; a memory 15 as a storage portion; and an input-output interface 11 as an input-output portion. The CPU 20, the memory 15, and the input-output interface 11 are connected such that they can communicate with one another through an internal bus. The memory 15 includes a ROM and a RAM. The CPU 20 serves as a control portion 21, a distance measuring portion 23, and an error detecting portion 25 by unarchiving and executing programs stored in the memory 15 and not shown in the figure. The CPU 20 may be a single CPU, a plurality of CPUs that execute the programs, or a multitasking CPU capable of executing multiple programs in parallel.

The control portion 21 controls the operation of the optical distance measuring apparatus 100 in whole by controlling the motor 52, the light emitting portion 40, and the light receiving portion 60.

The distance measuring portion 23 measures the distance to the object OB by calculating the time from emission of the irradiation light IL to receipt of the distance measurement reflected light RLm (TOF, which stands for time of flight) using a detection signal inputted from the light receiving portion 60. Hereinafter, measurement of the distance to the object OB by the distance measuring portion 23 is referred to as “distance measurement process”. In the present embodiment, the distance measurement process is performed while the irradiation light IL is forward-scanned in a direction in the scan angle range NR.

The error detecting portion 25 detects an error in the light emitting portion 40 (the light sources LD1, LD2, LD3, and LD4). The error detecting portion 25 detects an error in the light sources LD1, LD2, LD3, and LD4 while the light sources LD1, LD2, LD3, and LD4 emit light at different timings at which the distance measurement process is not performed. The clutter reflected light RLc serves to detect errors. The clutter reflected light RLc has an intensity considerably higher than ambient light or the distance measurement reflected light RLm because it is the light reflected in close proximity of the light emitting portion 40. So, the use of the signal value of the clutter reflected light RLc received by the light receiving portion 60 will produce a higher accuracy in detecting an error in LD1, LD2, LD3, and LD4. For example, the error detecting portion 25 detects an error such as that the light sources LD1, LD2, LD3, and LD4 have a quantity of light smaller than in normal operation or that the light sources LD1, LD2, LD3, and LD4 fail to emit light. Hereinafter, error detection in the light emitting portion 40 by the error detecting portion 25 is referred to as “error detection process”. In the present embodiment, an error detection process is performed while the irradiation light IL is being backward-scanned in a direction in the scan angle range NR, i.e., during the scan angle forward-scanned in a direction in the distance measurement process being returned to the scan angle before the distance measurement process is performed.

The input-output interface 11 is connected to the light receiving portion 60, the light emitting portion 40, and the motor 52 through different control signal lines. The input-output interface 11 transmits a light emission control signal to the light emitting portion 40, receives an incident light intensity signal from the light receiving portion 60, and transmits a rotation angle indication signal to the motor 52.

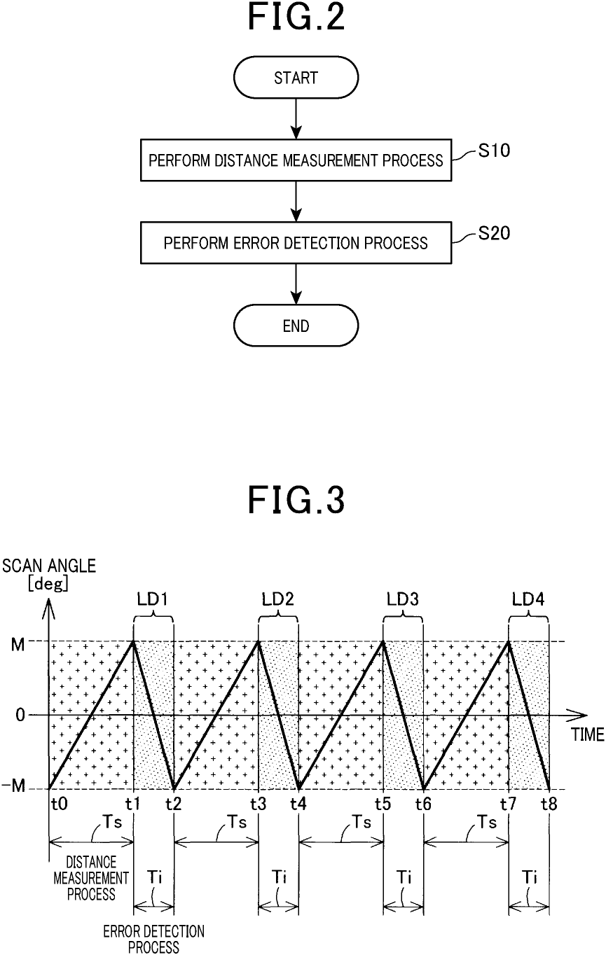

FIG. 2 shows a control process to be repeatedly performed at a predetermined interval of time, for example, an interval of a few hundred milliseconds from startup to shutdown of a vehicle control system or from turn-on to turn-off of a vehicle start switch. In Step S10, the distance measuring portion 23 performs the distance measurement process. Specifically, the distance measuring portion 23 causes the light emitting portion 40 to emit the irradiation light IL and dcauses the scanning portion 50 to scan the irradiation light IL in a first scan direction. The distance measuring portion 23 calculates a TOF using a received light signal of the reflected light RLm to measure the distance to the object OB.

In Step S20, the error detecting portion 25 performs the error detection process. In the error detection process of the present embodiment, the present or absence of errors in any one of the four light sources LD1, LD2, LD3, and LD4 that is a target of error detection is detected. Specifically, the error detecting portion 25 causes only one of the four light sources LD1, LD2, LD3, and LD4 that is a target of error detection to emit the irradiation light IL, and causes the scanning portion 50 to scan the irradiation light IL in a second scan direction (opposite to the first scan direction in which the irradiation light IL is scanned in the distance measurement process). Subsequently, the error detecting portion 25 obtains the incident light intensity signal of the clutter reflected light RLc. By comparing the signal value of the incident light intensity signal to a predetermined reference value, the error detecting portion 25 detects the presence or absence of an error in the light source that emitted the irradiation light IL. For example, when the signal value of the incident light intensity signal of the clutter reflected light RLc is less than the predetermined reference value, the presence of an error is detected: the light source has a low quantity of light. For another example, when the value indicated by the incident light intensity signal of the clutter reflected light RLc is 0 (zero), the presence of an error is detected: the light source fails to emit light. To detect the presence or absence of an error in all the four light sources LD1, LD2, LD3, and LD4, the error detection process needs to be performed four times in order while the target of error detection is changed, as described later with reference to FIG. 3.

In a timing diagram shown in FIG. 3, the horizontal axis represents time and the vertical axis represents the scan angle of the irradiation light IL. Upon activation of the control process at a time t0, Step S10 described above takes place: the distance measurement process is performed in a period Ts from the time t0 to a time t1. In the period Ts, the light source LD1 emits light intermittently in the form of short pulses under duty control. The on-duty ratio is less than 1%, for example. Meanwhile, the emitted irradiation light IL is scanned in the scan angle range from -M[deg] to M[deg]. In the present embodiment, the period Ts is 100 milliseconds, for example.

Upon completion of the distance measurement process at the time t1, Step S20 described above takes place: the error detection process is performed on the light source LD1 in a period Ti from the time t1 to a time t2. In the period Ti, the light source LD1 emits light intermittently in the form of short pulses under duty control. The on-duty ratio in the error detection process may be less than the on-duty ratio in the distance measurement process. The light sources LD, which are laser diodes, have a lifetime in emission; the lifetime of the light sources LD can be effectively used by driving the light sources LD at an on-duty ratio that achieves a quantity of light required for the error detection process. While the light source LD1 that is a target of error detection emits the irradiation light IL, the other light sources LD2, LD3, and LD4 do not emit the irradiation light IL. The emitted irradiation light IL is scanned in the second scan direction; specifically, it is scanned in the scan angle range from M[deg] to -M[deg]. This means, the scan angle in the distance measurement process and the scan angle in the error detection process on the light source LD1 are the same. In the present embodiment, the period Ti is 20 milliseconds, for example. The period Ti is not limited to 20 milliseconds; it may be any desired time from 5 to 30 milliseconds, for example. It is preferred that the period Ti be shorter than the period Ts described above.

Upon completion of the error detection process on the light source LD1 at the time t2, the distance measurement process is performed in a period Ts from the time t2 to a time t3. After that, the error detection process is performed on the light source LD2 in a period Ti from the time t3 to a time t4. As in the error detection process on the light source LD1, only the light source LD2 that is a target of error detection emits the irradiation light IL, and the emitted irradiation light IL is scanned in the scan angle range from M[deg] to -M[deg].

After the distance measurement process is performed in a period Ts from the time t4 to a time t5, the error detection process is performed on the light source LD3 in a period Ti from the time t5 to a time t6. Only the light source LD3 that is a target of error detection emits the irradiation light IL, and the emitted irradiation light IL is scanned in the scan angle range from M[deg] to -M[deg].

After the distance measurement process is performed in a period Ts from the time t6 to a time t7, the error detection process is performed on the light source LD4 in a period Ti from the time t7 to a time t8. Only the light source LD4 that is a target of error detection emits the irradiation light IL, and the emitted irradiation light IL is scanned in the scan angle range from M[deg] to -M[deg]. After that, the distance measurement process and the error detection process on the light sources LD1, LD2, LD3, and LD4 are alternately repeated until turn-off of the vehicle control system or the vehicle start switch.

According to the present embodiment, the optical distance measuring apparatus 100 having the configuration described above performs an error detection process of detecting an error in the light emitting portion 40 using the clutter reflected light RLc obtained by the irradiation light IL being reflected inside the case 80, the irradiation light IL being emitted in the period Ti when the distance measurement process is not performed. So, it is capable of detecting an error in the light emitting portion 40 without being provided with a light guiding portion for detecting an error in the light emitting portion 40. This will prevent an increase in the number of components of the optical distance measuring apparatus 100 and in the size of the optical distance measuring apparatus 100.

Since the irradiation light IL emitted in the distance measurement process and the irradiation light IL emitted in the error detection process are both scanned in the same scan angle range NR, the light emitting portion 40 and the scanning portion 50 do not need to switch their processes depending on whether the distance measurement process or the error detection process. This will prevent an increase in the complexity of the control of the light emitting portion 40 and the scanning portion 50. The error detection process is performed on the light sources LD1, LD2, LD3, and LD4 at different timings, which will bring a higher accuracy in detecting an error in the light sources LD1, LD2, LD3, and LD4 than in a configuration in which the light sources LD1, LD2, LD3, and LD4 emit light at the same timings and error detection in the light sources LD1, LD2, LD3, and LD4 is performed. In other words, it is difficult to identify the light source LD having an error in it in the distance measurement process because control is performed such that the light sources LD1 to LD4 emit light at an interval of a few microseconds. In contrast, it is easy to identify the light source LD having an error in it in the error detection process because control is performed such that the light sources LD1 to LD4 emit light separately in a period of each error detection process, as described above.

### B. Second Embodiment

In the error detection process of the first embodiment, the irradiation lights IL emitted from the light sources LD1, LD2, LD3, and LD4 are all scanned in the same scan angle range (from M[deg] to -M[deg]). In contrast, in the second embodiment, the light sources LD1, LD2, LD3, and LD4 emit the irradiation light IL to different scan angle ranges. In the present embodiment, the scan angle range NR is divided into a plurality of regions using the scan angle, and the light sources LD1, LD2, LD3, and LD4 emit the irradiation light IL to the respective regions.

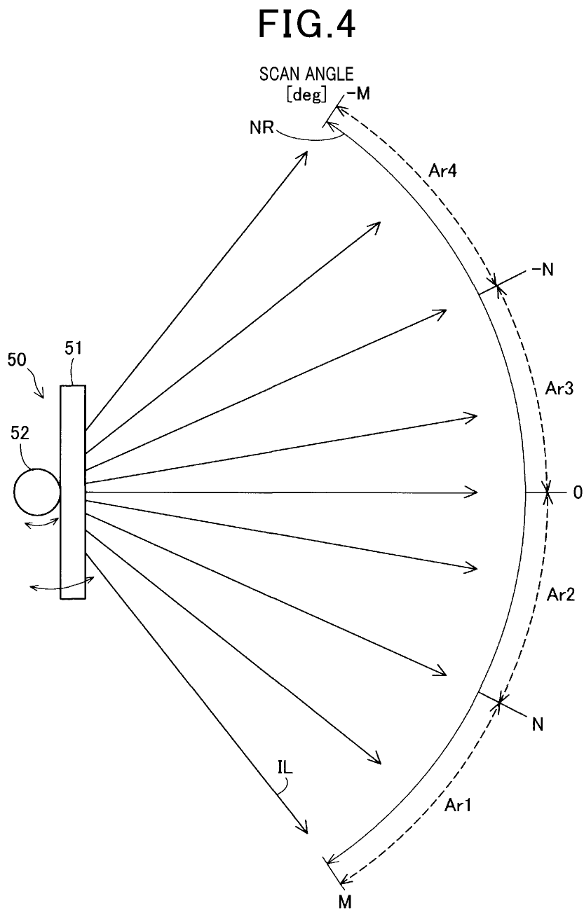

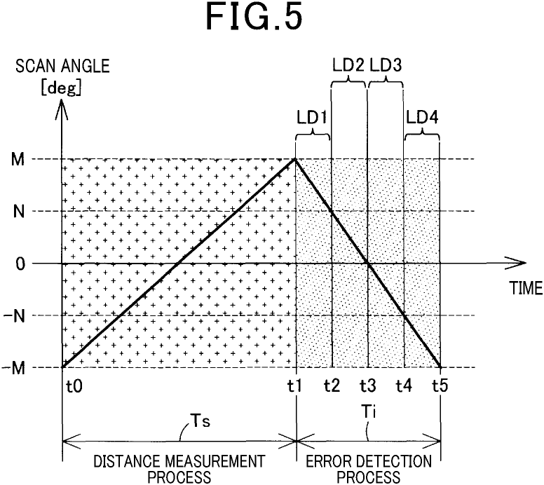

FIG. 4 shows the scan angle range NR that is divided into four regions Ar1, Ar2, Ar3, and Ar4 according to the scan angle. Specifically, the first section Ar1 is a section corresponding to a range from the scan angle M[deg] to N[deg] in the scan angle range NR. The second section Ar2 is a section corresponding to a range from the scan angle N[deg] to zero[deg] in the scan angle range NR. The third section Ar3 is a section corresponding to a range from the scan angle zero[deg] to -N[deg] in the scan angle range NR. The fourth section Ar4 is a section corresponding to a range from the scan angle -N[deg] to -M[deg] in the scan angle range NR. The scan angles M and N can be any angle that is desired based on experimental results or the like.

The irradiation light IL emitted from the light source LD1 is scanned in the first section Ar1. The irradiation light IL emitted from the light source LD2 is scanned in the second section Ar2. The irradiation light IL emitted from the light source LD3 is scanned in the third section Ar3. The irradiation light IL emitted from the light source LD4 is scanned in the fourth section Ar4. So, in the second embodiment, error detection in all the light sources LD1, LD2, LD3, and LD4 is completed in one backward-scan after the distance measurement process.

FIG. 5 shows a timing diagram of the control process in the second embodiment, in which the horizontal axis represents time and the vertical axis represents the scan angle of the irradiation light IL. Upon activation of the control process at a time t0, the distance measurement process is performed in a period Ts from the time t0 to a time t1. Meanwhile, the irradiation light IL is scanned in the scan angle range from -M[deg] to M[deg].

Upon completion of the distance measurement process at the time t1, the error detection process is performed on the light sources LD1, LD2, LD3, and LD4 in order in a period Ti from the time t1 to a time t5. Specifically, the error detection process is performed on the light source LD1 from the time t1 to a time t2, error detection in the light source LD2 is performed from the time t2 to a time t3, error detection in the light source LD3 is performed from the time t3 to a time t4, and error detection in the light source LD4 is performed from the time t4 and the time t5. In the error detection process on the light source LD1, the light source LD1 that is a target of error detection emits the irradiation light IL to the first section Ar1, and the irradiation light IL is scanned from a position corresponding to the scan angle M[deg] to a position corresponding to the scan angle N[deg]. As in the first embodiment, the error detecting portion 25 detects the presence or absence of an error in the light source LD1 using an incident light intensity signal of the clutter reflected light RLc.

In the error detection process on the light source LD2, the light source LD2 that is a target of error detection emits the irradiation light IL to the second section Ar2, and the irradiation light IL is scanned from the position corresponding to the scan angle N[deg] to a position corresponding to the scan angle zero[deg]. The presence or absence of an error in the light source LD2 is detected accordingly. In the error detection process on the light source LD3, the light source LD3 that is a target of error detection emits the irradiation light IL to the third section Ar3, and the irradiation light IL is scanned from the position corresponding to the scan angle zero[deg] to a position corresponding to the scan angle -N[deg]. The presence or absence of an error in the light source LD3 is detected accordingly. In the error detection process on the light source LD4, the light source LD4 that is a target of error detection emits the irradiation light IL to the fourth section Ar4, and the irradiation light IL is scanned from the position corresponding to the scan angle -N[deg] to a position corresponding to the scan angle -M[deg]. The presence or absence of an error in the light source LD4 is detected accordingly.

According to the second embodiment, in the error detection process, the optical distance measuring apparatus having the configuration described above causes the light emitting portion 40 to emit the irradiation light IL with the light sources LD1, LD2, LD3, and LD4, respectively, to the four regions Ar1, Ar2, Ar3, and Ar4 divided using the scan angle. So, error detection in the light sources LD1, LD2, LD3, and LD4 is completed in one backward-scan. This will reduce the time required for error detection in the light sources LD1, LD2, LD3, and LD4.

### C. Another Embodiment

In the embodiments described above, the optical distance measuring apparatus 100 performs the error detection process on the light emitting portion 40 using the clutter reflected light RLc obtained by the irradiation light IL being reflected inside the case 80, the irradiation light IL being emitted in the non-distance measurement period Ti. Alternatively, the optical distance measuring apparatus 100 may perform the error detection process using a reflection from a vehicle body that remains at a constant distance from the optical distance measuring apparatus 100 at all times, such as a roof or a bonnet.

In the embodiments described above, in the error detection process, the error detecting portion 25 uses a detection signal outputted from the light receiving portion 60, i.e., an incidence intensity signal, in the raw. In the error detection process, however, the light receiving portion 60 receives ambient light, too, such as a reflected light incident from outside the case 80 in response to light emission of the light emitting portion 40 and a reflected light incident from outside the case 80 in response to sunlight or artificial light such as street lights, for example. In order to achieve a higher accuracy in the error detection process, the error detecting portion 25 may perform a process of increasing the SN of the clutter reflected light RLc, i.e., a process of increasing the SN of an incidence intensity signal in the detection signal, corresponding to the clutter reflected light RLc. As described above, the clutter reflected light RLc, a reflected light from inside the case 80 in the proximity of the light emitting portion 40, has a TOF very much shorter than the ambient light and an incidence intensity higher than the ambient light. Here below are some examples.

(a) The error detecting portion 25 may subject the detection signal from the light receiving portion 60 to time filter, and achieve an increase in the SN of the incidence intensity signal of the clutter reflected light RLc by performing a time-filter process of extracting a detection signal in a time range corresponding to the TOF of the clutter reflected light RLc. In this case, an incidence intensity signal caused by the ambient light having a TOF longer than the clutter reflected light RLc is filtered out, which results in an increase in the SN of the incidence intensity signal of the clutter reflected light RLc. The time-filter process may be performed by the error detecting portion 25; alternatively, it may be performed by the light receiving portion 60 in accordance with a control signal from the error detecting portion 25.

(b) The error detecting portion 25 may achieve an increase in the SN of the incidence intensity signal of the clutter reflected light RLc by lowering the light receiving sensitivity of the light receiving portion 60, i.e., by reducing the quantity of signal amplification. Incidence intensity signals of the clutter reflected light RLc are much stronger than incidence intensity signals of the ambient light. So, a low light receiving sensitivity disables receipt of incidence intensity signals caused by the ambient light, which results in an increase in the SN of the incidence intensity signal of the clutter reflected light RLc.

(c) The error detecting portion 25 may lower the luminous intensity of the light emitting portion 40 to shorten the detection distance and achieve an increase in the SN of the incidence intensity signal of the clutter reflected light RLc. Since the case 80 is closer to the light emitting portion 40 than any outside object, a low luminous intensity enables entry of the clutter reflected light RLc into the light receiving portion 60 from the case 80. In contrast, a low luminous intensity disables access of light to any outside object that is positioned away from the light emitting portion 40 or hardly enables entry of the ambient light, which is a reflected light from outside objects, into the light receiving portion 60. This results in an increase in the SN of the incidence intensity signal of the clutter reflected light RLc.

In the embodiments described above, the optical distance measuring apparatus 100 having the scanning portion 50 that mechanically performs scanning is employed. Alternatively, an optical distance measuring apparatus that is provided with, instead of the scanning portion 50, a non-mechanical scanning portion provided with no mechanical moving part may be employed. As a non-mechanical scanning portion, a scanning portion having no moving part that electronically and repeatedly performs scanning in its scan angle range, such as a liquid-crystal scanner or an optical phased-array (OPA) may be employed. Even in a case in which such a non-mechanical scanning portion is employed, there is a non-distance measurement period, so the error detection process described above can be performed in a non-distance measurement period.

In the embodiments described above, the light emitting portion 40 that is provided with the four light sources LD1, LD2, LD3, and LD4 as an example of multiple light sources is employed. Alternatively, the light emitting portion 40 may be provided with one, two, three, five or more light sources.

The portions such as the control portion and the methods thereof, described in the present disclosure may be achieved by a dedicated computer configured with: a processor that is programmed to execute one or more functions implemented by computer programs; and a memory. Alternatively, the portions such as the control portion and the methods thereof, described in the present disclosure may be achieved by a dedicated computer configured with a processor that consists of one or more dedicated hardware logic circuits. Otherwise, the control portion and the method thereof, described in the present disclosure may be achieved by one or more dedicated computers configured with a combination of: a processor that is programmed to execute one or more functions, along with a memory; and a processor that consists of one or more hardware logic circuits. The computer programs may be stored in a tangible, non-transitory computer-readable recording medium as instructions to be followed by the computer.

The present disclosure should not be limited to the embodiments described above, and can be diversely configured to the extent with which its essential points fall. For example, in order to address the problems described above in whole or in part or to obtain the effects described above in whole or in part, technical features of the embodiments, corresponding to the technical features of the embodiments described in Summary of the Invention can be replaced or combined appropriately. Furthermore, the technical features can be omitted as necessary if not defined in the present specification that they are essential.

What is claimed is:

1. An optical distance measuring apparatus comprising:
a light emitting portion configured to emit irradiation light;
a light receiving portion configured to output a signal according to an intensity of incident light, the incident light including a reflected light resulting from the emitted irradiation light;
a case that accommodates the light emitting portion and the light receiving portion;
a distance measuring portion configured to perform a distance measurement process of measuring a distance to an object according to the intensity of the incident light; and
an error detecting portion configured to perform an error detection process of detecting an error in the light emitting portion using a reflected light resulting from the irradiation light emitted in a period when the distance measurement process is not performed.

2. The optical distance measuring apparatus according to claim 1, wherein
the error detecting portion is configured to detect an error in the light emitting portion using a reflected light resulting from the irradiation light reflected inside the case.

3. The optical distance measuring apparatus according to claim 2, wherein
the error detecting portion is configured to increase an SN of the reflected light reflected inside the case to detect an error in the light emitting portion.

4. The optical distance measuring apparatus according to claim 1, further comprising
a scanning portion configured to mechanically scan the emitted irradiation light back and forth in a scan angle range,
wherein
the irradiation light emitted in the distance measurement process and the irradiation light emitted in the error detection process are both scanned in the same scan angle range.

5. The optical distance measuring apparatus according to claim 1, further comprising
a scanning portion configured to electronically scan the emitted irradiation light back and forth in a scan angle range,
wherein the irradiation light emitted in the distance measurement process and the irradiation light emitted in the error detection process are both scanned in the same scan angle range.

6. The optical distance measuring apparatus according to claim 1, wherein:
the light emitting portion comprises a plurality of light sources; and
and the error detecting portion is configured to perform the error detection process on each of the light sources at different timings.

7. The optical distance measuring apparatus according to claim 6, further comprising:
a scanning portion configured to scan the emitted irradiation light back and forth in a predetermined scan angle range; and
a control portion configured to control a scan angle of the scanning portion,
wherein, the light emitting portion is configured to, in the error detection process, emit the irradiation light using the different light sources for each of a plurality of regions divided using the scan angle.
